(19) United States
(12) Patent Application Publication
(10) Pub. No.: US 2013/0301760 A1
(43) Pub. Date: Nov. 14, 2013

(54) METHODS, APPARATUS AND COMPUTER PROGRAMS FOR SIGNAL INTERFERENCE RATIO ESTIMATION

(71) Applicant: RENESAS MOBILE CORPORATION, Tokyo (JP)

(72) Inventor: Jukka Pekka Tapaninen, Espoo (FI)

(73) Assignee: RENESAS MOBILE CORPORATION, Tokyo (JP)

(21) Appl. No.: 13/875,872

(22) Filed: May 2, 2013

(30) Foreign Application Priority Data
May 10, 2012 (GB) 1208219.4

(51) Int. Cl. H04L 27/38

(52) U.S. Cl. CPC H04L 27/38
USPC 375/340

(57) ABSTRACT

Methods, apparatus and computer programs are provided for performing signal interference ratio estimation with respect particularly to non-constant modulus data. A method is provided that includes causing one or more data symbols to be demodulated resulting in one or more soft bits. An estimate is determined for a second order moment and a fourth order moment for the one or more soft bits. A signal to noise ratio is determined based on a signal component and a noise component of the estimated second order moment and the estimated fourth order moment for the one or more soft bits.

### CROSS REFERENCE TO RELATED APPLICATIONS

This application claims priority to United Kingdom Application No. 1208219.4, filed on May 10, 2012, the entire contents of which are hereby incorporated by reference.

### TECHNICAL FIELD

The present invention relates to methods, apparatus and computer programs for signal interference ratio estimation. Embodiments of the present invention relate generally to communications technology and, more particularly, to example signal to noise or signal interference ratio estimation.

### BACKGROUND

Signal to noise ratio (SNR), signal to interference ratio (SIR) and/or signal to noise and interference ratio (SINR) estimation is a functionality that may be performed by an example receiver, such as by a mobile terminal, user equipment and/or the like. The SNR, SIR and/or SINR estimation and/or measurement may be used in some examples for power control, signal detection, adaptive modulation and coding (AMC), and/or channel quality indicator (CQI). In some examples, SNR, SIR and/or SINR estimation may be used in Wideband Code Division Multiple Access (WCDMA) downlink dedicated physical channel (DPCH) transmissions, because the power level in such a transmission is controlled by feedback from a mobile terminal. The feedback provided is based on the SIR measurement on a DPCH channel. In some examples, SNR, SIR and/or SINR estimation may also be used for reporting purposes by a receiver and/or by an internal communication device such as a modem. For example, an SNR, SIR and/or SINR estimation or measurement may, for example, be used as a measure of signal quality, to dynamically change parameter values of algorithms or to select a mode of operation.

### SUMMARY

According to a first aspect of the present invention, there is provided a method of signal to noise/interference ratio estimation, the method comprising: causing one or more data symbols to be demodulated resulting in one or more soft bits; determining an estimate for a second order moment and a fourth order moment using at least some of the one or more soft bits; and estimating a signal to noise/interference ratio based on the estimated second order moment and the estimated fourth order moment for the one or more soft bits.

According to a second aspect of the present invention, there is provided a method of signal to noise/interference ratio estimation, the method comprising: determining whether one or more received data symbols are received via a constant modulus signal or a non-constant modulus signal; and (a) in the case that one or more of the received data symbols are received via a constant modulus signal: determining an estimate for a second order moment and a fourth order moment using the one or more of the data symbols that are received via a constant modulus signal, and determining a signal to noise/interference ratio based on the estimated second order moment and the estimated fourth order moment for the one or more data symbols that are received via a constant modulus signal; and (b) in the case that one or more of the received data symbols are received via a non-constant modulus signal: determining an estimate for a second order moment and a fourth order moment using at least some of one or more soft bits that are output by a demodulator which demodulates the one or more received data symbols, and estimating a signal to noise/interference ratio based on the estimated second order moment and the estimated fourth order moment for the one or more soft bits.

According to a third aspect of the present invention, there is provided apparatus for signal to noise/interference ratio estimation, the apparatus comprising: a processing system arranged to cause the apparatus to at least: cause one or more data symbols to be demodulated resulting in one or more soft bits; determine an estimate for a second order moment and a fourth order moment using at least some of the one or more soft bits; and estimate a signal to noise/interference ratio based on the estimated second order moment and the estimated fourth order moment for the one or more soft bits.

According to a fourth aspect of the present invention, there is provided apparatus for signal to noise/interference ratio estimation, the apparatus comprising: a processing system arranged to cause the apparatus to at least: determine whether one or more received data symbols are received via a constant modulus signal or a non-constant modulus signal; and (a) in the case that one or more of the received data symbols are received via a constant modulus signal: determine an estimate for a second order moment and a fourth order moment using the one or more of the data symbols that are received via a constant modulus signal, and determine a signal to noise/interference ratio based on the estimated second order moment and the estimated fourth order moment for the one or more data symbols that are received via a constant modulus signal; and (b) in the case that one or more of the received data symbols are received via a non-constant modulus signal: determine an estimate for a second order moment and a fourth order moment using at least some of one or more soft bits that are output by a demodulator which demodulates the one or more received data symbols, and estimate a signal to noise/interference ratio based on the estimated second order moment and the estimated fourth order moment for the one or more soft bits.

According to a fifth aspect of the present invention, there is provided a computer program for signal to noise/interference ratio estimation comprising a set of instructions, which, when executed on an apparatus, causes the apparatus to perform the steps of: causing one or more data symbols to be demodulated resulting in one or more soft bits; determining an estimate for a second order moment and a fourth order moment using at least some of the one or more soft bits; and estimating a signal to noise/interference ratio based on the estimated second order moment and the estimated fourth order moment for the one or more soft bits.

According to a sixth aspect of the present invention, there is provided a computer program for signal to noise/interference ratio estimation comprising a set of instructions, which, when executed on an apparatus, causes the apparatus to perform the steps of: determining whether one or more received data symbols are received via a constant modulus signal or a non-constant modulus signal; and (a) in the case that one or more of the received data symbols are received via a constant modulus signal: determining an estimate for a second order moment and a fourth order moment using the one or more of the data symbols that are received via a constant modulus signal, and determining a signal to noise/interference ratio based on the estimated second order moment and the estimated fourth order moment for the one or more data symbols that are received via a constant modulus signal; and (b) in the case that one or more of the received data symbols are received via a non-constant modulus signal: determining an estimate for a second order moment and a fourth order moment using at least some of one or more soft bits that are output by a demodulator which demodulates the one or more received data symbols, and estimating a signal to noise/interference ratio based on the estimated second order moment and the estimated fourth order moment for the one or more soft bits.

According to a seventh aspect of the present invention, there is provided apparatus for signal to noise/interference ratio estimation, the apparatus comprising: means for causing one or more data symbols to be demodulated resulting in one or more soft bits; means for determining an estimate for a second order moment and a fourth order moment using at least some of the one or more soft bits; and means for estimating a signal to noise/interference ratio based on the estimated second order moment and the estimated fourth order moment for the one or more soft bits.

According to an eighth aspect of the present invention, there is provided apparatus for signal to noise/interference ratio estimation, the apparatus comprising: means for determining whether one or more received data symbols are received via a constant modulus signal or a non-constant modulus signal; and (a) in the case that one or more of the received data symbols are received via a constant modulus signal: determining an estimate for a second order moment and a fourth order moment using the one or more of the data symbols that are received via a constant modulus signal, and determining a signal to noise/interference ratio based on the estimated second order moment and the estimated fourth order moment for the one or more data symbols that are received via a constant modulus signal; and (b) in the case that one or more of the received data symbols are received via a non-constant modulus signal: determining an estimate for a second order moment and a fourth order moment using at least some of one or more soft bits that are output by a demodulator which demodulates the one or more received data symbols, and estimating a signal to noise/interference ratio based on the estimated second order moment and the estimated fourth order moment for the one or more soft bits.

The apparatus described above may include at least one processor and at least one memory including computer program code with the at least one memory and the computer program code being configured, with the at least one processor, to cause the apparatus to at least operate as described above.

The computer program described above may be provided as a computer program product that includes at least one non-transitory computer-readable storage medium having computer-readable program instructions stored therein.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a schematic representation of an example of a system having a mobile terminal that may perform SIR estimation and that may benefit from example embodiments of the present invention;

FIG. 2 shows a block diagram of an example of an apparatus that may be embodied by a communication device and/or an access point in accordance with some example embodiments of the present invention;

FIG. 3 shows a flow chart illustrating an example of operations performed by an example receiver in accordance with some example embodiments of the present invention; and

FIG. 4 shows a flow chart illustrating an example of operations performed by an example receiver in accordance with some example embodiments of the present invention.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

As is disclosed herein, the signal to noise ratio (SNR), signal to interference ratio (SIR) and/or signal to noise and interference ratio (SINR) may be used interchangeably and as such SIR may be used throughout the disclosure and claims. The term SIR should be construed to cover and or be used interchangeably with SNR and/or SINR. Further, example embodiments are disclosed herein that relate to WCDMA frequency division duplex (FDD)/time division duplex (TDD) (e.g. Time Division Synchronous Code Division Multiple Access (TD-SCDMA)) systems. However, the systems and methods described herein should not be limited to such a system, but should be considered to apply to all radio access systems, such as but not limited to Third Generation (3G) cellular systems (e.g. TD-SCDMA, Code Division Multiple Access (CDMA) 2000 1× Evolution-Data Optimized or Evolution-Data Only (EVDO)), 3.9G systems (Long Term Evolution (LTE™)) and any future radio access systems as well as non-cellular systems (e.g. Institute of Electrical and Electronics Engineers (IEEE™) 802.11).

In some example embodiments, SIR estimation may be implemented based on data output (e.g. data channel symbols) from a detector in a receiver (e.g. a mobile terminal, wireless station, communications device, user equipment and/or the like) and may be configured such that it reflects a SIR of the demodulated and/or decoded data. Alternatively or additionally, a pilot channel may be used for SIR estimation and measurement. For example in WCDMA FDD, a common pilot channel (CPICH) may be used for SIR measurement and/or estimation purposes. In some examples, a synchronization channel may be used for SIR measurement and/or estimation. Other example SIR measurement and/or estimation may be based on common channels (e.g. Primary Common Control Physical Channel (P-CCPCH) in WCDMA FDD/TDD), user specific midamble transmissions and/or the like.

Alternatively or additionally, the use of the detector output data from SIR estimation may be configured to allow for implementation in the example cases where different diversity modes are supported. An example is the case in which diversity combining (e.g. transmit diversity and/or receive diversity including oversampling) is accomplished by an example detector.

In some example embodiments, the methods, apparatus and computer program products as described herein are configured to obtain SIR estimates for a wide range of operations including, but not limited to, a wide range of channel geometries as well as a variety of received SIR values. The methods, apparatus and computer program products as described herein are further configured for application in a data channel transmission where modulation with non-constant modulus and/or constant modulus is used. In some example embodiments and with respect to constant modulus data, the SIR estimation may be based on an estimation of a second order moment (M₂) and a fourth order moment (M₄) of one or more data symbols sampled from the output of a detector. In some examples, such an estimation may be referred to as an M₂M₄ estimation. The M₂M₄ estimation may be used to estimate the SIR.

However, in the case of non-constant modulus data, the one or more data symbols sampled from the detector may, for example, be advantageously demodulated (e.g. by a slicer algorithm or the like). Once the one or more data symbols are demodulated, those samples (e.g. soft bits) that correspond to a constant amplitude may be used to recalculate the estimates for M₂ and M₄. The recalculated M₂M₄ estimation may then be used to estimate the SIR.

Alternatively or additionally and in an instance in which the one or more data symbols that are sampled from the detector are determined to be noisy, the methods, apparatus and computer program products as described herein may further be configured to determine whether to use the M₂ and M₄ estimates based on the one or more data symbols output by the detector or the M₂ and M₄ estimates based on the demodulated one or more data symbols (e.g. soft bits) for SIR estimation. The determination may be based on a predetermined threshold, a ratio test, and/or the like.

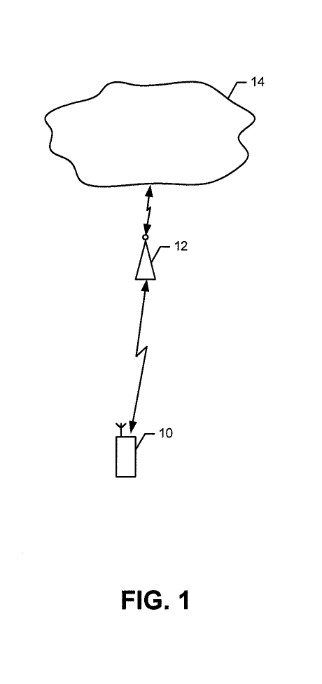

Although the method, apparatus and computer program product as described herein may be implemented in a variety of different systems, one example of such a system is shown in FIG. 1, which includes a communication device (e.g. communication device 10) that is capable of communication via an access point 12, such as a base station, a macro cell, a Node B, an eNB, a coordination unit, a macro base station or other access point, with a network 14 (e.g. a core network). While the network may be configured in accordance with LTE™ or LTE-Advanced (LTE-A™), other networks may support the method, apparatus and computer program product of embodiments of the present invention including those configured in accordance with Wideband Code Division Multiple Access (W-CDMA™), CDMA2000, Global System for Mobile Communications (GSM™), General Packet Radio Service (GPRS™), IEEE 802.11 standard for wireless fidelity (WiFi™), wireless local access network (WLAN) Worldwide Interoperability for Microwave Access (WiMAX™) protocols, and/or the like.

The network 14 may include a collection of various different nodes, devices or functions that may be in communication with each other via corresponding wired and/or wireless interfaces. For example, the network may include one or more cells, including access point 12 and which may serve a respective coverage area. The access point 12 could be, for example, part of one or more cellular or mobile networks or public land mobile networks (PLMNs). In turn, other devices such as processing devices (e.g. personal computers, server computers or the like) may be coupled to the communication device 10 and/or other communication devices via the network.

A communication device, such as the communication device 10 (also known as user equipment (UE), a mobile terminal or the like), may be in communication with other communication devices or other devices via the access point 12 and, in turn, the network 14. In some cases, the communication device 10 may include an antenna for transmitting signals to and for receiving signals from an access point 12. As is described herein the communication device 10 and/or the access point 12 may take the form of a transmitter and/or receiver.

In some example embodiments, the communication device 10 may be a mobile communication device such as, for example, a mobile telephone, portable digital assistant (PDA), pager, laptop computer, STA, or any of numerous other hand held or portable communication devices, computation devices, content generation devices, content consumption devices, or combinations thereof. However, as is described herein, the communication device 10 may also take the form a communications enabled appliance, such as a thermostat configured to connect with an access point 12. Other such devices that are configured to connect to the network include, but are not limited to a refrigerator, a security system, a home lighting system, and/or the like. As such, the communication device 10 may include one or more processors that may define processing circuitry and a processing system, either alone or in combination with one or more memories. The processing circuitry may utilize instructions stored in the memory to cause the communication device 10 to operate in a particular way or execute specific functionality when the instructions are executed by the one or more processors. The communication device 10 may also include communication circuitry and corresponding hardware/software to enable communication with other devices and/or the network 14.

In some example embodiments, an access point 12 may function as the transmitter and a communication device 10 may function as the receiver. However, it may be envisioned that either the access point 12 or the communication device 10 may function as the transmitter and either the access point 12 or the communication device 10 may function as the receiver. As such the terms as used herein may be used interchangeably to apply to the identified devices operating a network.

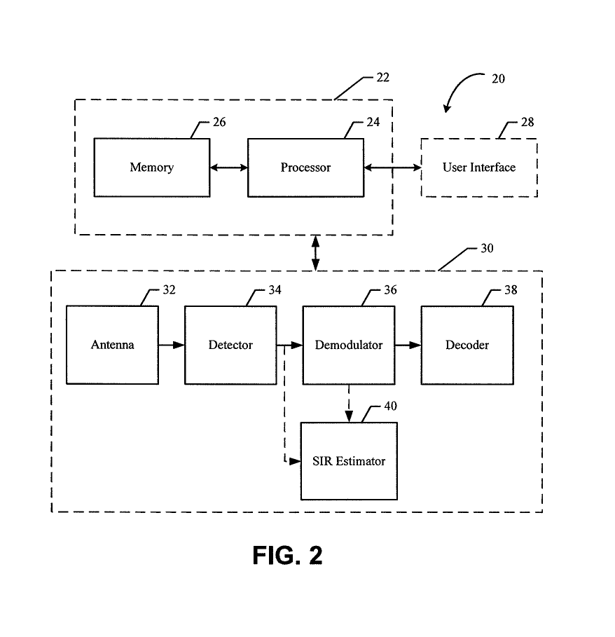

In one embodiment, for example, the communication device 10 and/or the access point 12 may be embodied as or otherwise include an apparatus 20 as generically represented by the block diagram of FIG. 2. While the apparatus 20 may be employed, for example, by a communication device 10 or an access point 12, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution, SIR estimation, and/or other processing and management services according to an example embodiment of the present invention. In some embodiments, the apparatus or the processing circuitry may be embodied as a chip or chipset. In other words, the apparatus or the processing circuitry may comprise one or more physical packages (e.g. chips) including materials, components and/or wires on a structural assembly (e.g. a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a communication interface 30 and, in some cases, a user interface 28. As such, the processing circuitry may be embodied as a circuit chip (e.g. an integrated circuit chip) configured (e.g. with hardware, software or a combination of hardware and software) to perform operations described herein. However, in some embodiments taken in the context of the communication device 10, the processing circuitry may be embodied as a portion of a mobile computing device or other mobile terminal. Alternatively or additionally, the processing circuitry 22 and the processor 24, may include, control or otherwise be in communication with one or more of an antenna 32, detector 34, demodulator 36, decoder 38 and/or SIR estimator 40.

The user interface 28 (if implemented) may be in communication with the processing circuitry 22 to receive an indication of a user input at the user interface and/or to provide an audible, visual, mechanical or other output to the user. As such, the user interface may include, for example, a keyboard, a mouse, a trackball, a display, a touch screen, a microphone, a speaker, and/or other input/output mechanisms. The apparatus 20 need not always include a user interface. For example, in instances in which the apparatus is embodied as an access point 12, the apparatus may not include a user interface. As such, the user interface is shown in dashed lines in FIG. 2.

The communication interface 30 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 14 and/or any other device or module in communication with the processing circuitry 22, such as between the communication device 10 and the access point 12. In this regard, the communication interface may include, for example, an antenna 32 (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. For example, the communication interface 30 may include a detector 34, a demodulator 36, a decoder 38 and/or an SIR estimator 40.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory may be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor 24 via a bus for passing information among components of the apparatus.

The processor 24 may be embodied in a number of different ways. For example, the processor 24 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g. physically embodied in circuitry, such as in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

In some example embodiments, a SIR estimation for a signal received by the communication interface 30 may be generated such as by the processing circuitry 22, the processor 24, the SIR estimator 40 and/or the like. A model for SIR estimation, as used herein, may include, but is not limited to:

yₙ=hₙxₙ+wₙ (1)

where yₙ, xₙ, hₙ and wₙ denote a received signal, transmitted symbol, channel coefficient and noise, respectively. In some example embodiments, it may be assumed that noise is a complex Gaussian with zero mean and variance 2σ².

In some example embodiments, and given received samples yₙ, an SIR estimation can be defined as:

$$SIR ( y ) = \frac{{\vert h \vert}^{2} {σ}_{x}^{2}}{2 {σ}^{2}} \qquad ( 2 )$$

where σₓ² equals the power of transmitted signal x. In some example embodiments, x is an arbitrary constellation having Q different amplitude levels A₁, A₂, . . . , A_{Q} with probabilities p₁, p₂, . . . , p_{Q}. For example, for 16 QAM, Q=3. Further, the distribution of |yₙ| has mixed Ricean density given by:

$$pdf ( \vert y \vert ) = {\sum }_{i = 1}^{Q} {p}_{i} \frac{{y}_{n}}{{σ}^{2}} exp ( - {ρ}_{i} - \frac{{\vert {y}_{n} \vert}^{2}}{2 {σ}^{2}} ) {I}_{o} ( {y}_{n} \sqrt{\frac{2 {ρ}_{i}}{{σ}^{2}}} ) \qquad ( 3 )$$

where Iₒ refers to a modified Bessel function of the first kind and order zero and where

$${ρ}_{i} = \frac{{\vert {h}_{i} \vert}^{2} {A}_{i}^{2}}{{N}_{o}} = \frac{{\vert {h}_{i} \vert}^{2} {A}_{i}^{2}}{2 {σ}^{2}} .$$

Further, a moment based SIR estimate (e.g. M₂M₄ estimator) may then be derived, in some example embodiments, as:

$$SIR ( y ) = \frac{1 - 2 \frac{{M}_{2}^{2}}{{M}_{4}} - \sqrt{( 2 - a ) ( \frac{2 {M}_{2}^{4}}{{M}_{4}^{2}} - \frac{{M}_{2}^{2}}{{M}_{4}} )}}{a \frac{{M}_{2}^{2}}{{M}_{4}} - 1} \qquad ( 4 )$$

where a=Σᵢ₌₁^{Q}pᵢAᵢ⁴. In some examples, quantity a is a pre-calculated constant assuming a random transmitted signal (indicating probabilities pᵢ are known a priori). M₂, M₄ are the second order and fourth order moments of y, which can be estimated using sample size N as:

$$\{ \begin{matrix}{M}_{2} = \frac{1}{N} {\sum }_{i = 1}^{N} {y}_{n} {y}_{n}^{′} \\ {M}_{4} = \frac{1}{N} {\sum }_{i = 1}^{N} {( {y}_{n} {y}_{n}^{′} )}^{2}\end{matrix} \qquad ( 5 )$$

where operator (′) indicates complex conjugation.

Referring again to FIG. 2, a signal may be received by the communication interface 30, such as via the antenna 32. One or more data samples may be output by the antenna 32 and then input into the detector 34. The detector 34, in some example embodiments, may take the form of a RAKE or LMMSE (linear minimum mean squared error) equalizer (e.g. chip level, symbol level) detector. In some example embodiments, the detector 34 may be configured to calculate moments M₂, M₄ according to Equation (5) for a data vector of length N symbols. The detector 34 may then output one or more data symbols. The data symbols may then be used by the SIR estimator 40 in calculating an SIR estimate. By way of example, an equation, such as equation (4), may be used by the SIR estimator 40 for calculating the SIR estimate.

As is described herein, equation (4) is configured for operation with calculated moments M₂, M₄ according to Equation (5) in an instance in which the data processed has a constant modulus. However, the SIR estimator 40 may also be configured to input demodulated data from the demodulator 36 in an instance in which non-constant modulus data is received. The processing circuitry 22, the processor 24 and/or the like may be configured to determine whether constant and/or non-constant modulus data is received.

In some example embodiments, the output of the demodulator 36 may be input into the SIR estimator 40. The input of the SIR estimator 40 may include demodulated symbols (e.g. soft bits) which have a constant amplitude. In some example embodiments, the demodulator 36 may implement a slicer algorithm to obtain the soft bits. An example is the following slicer algorithm for 16 QAM modulated data:

$$\{ \begin{matrix}s 0 = real ( s ) \\ s 1 = imag ( s ) \\ s 2 = Th - abs ( real ( s ) ) \\ s 3 = Th - abs ( imag ( s ) )\end{matrix} \qquad ( 6 )$$

where s indicates a data symbol output by the detector 34, Th is a threshold which, as a specific example, for the normalised constellation (data symbol power equals unity) in some example embodiments is represented by Th=2/\sqrt{10}, and abs( ) refers to an absolute value. In some embodiments, abs( ) may be replaced by |x|, for example: abs(x)=|x|. The variable Th may be calculated for each constellation. The value of Th may be mathematically calculated, in some example embodiments, for each constellation based on an average energy value normalised to unity. Such values may be determined, such as by the processing circuitry 22, the processor 24 or the like. In some examples, the threshold may be obtained by augmenting the theoretical value by estimated symbol amplitude. As a specific example, in some example embodiments, soft bits s2 and s3 have a constant amplitude /\sqrt{10}, whereas soft bits s0 and s1 may be centered around 1/\sqrt{10} and 3/\sqrt{10}. Therefore, in some example embodiments, soft bits s2, s3 are selected for further processing because of the determined constant amplitude.

In some example embodiments, the method of SIR estimation using 16 QAM modulated data may include, but is not limited to, replacing the one or more data symbols output from the detector 34 with the demodulated symbols s2, s3 as calculated using equation (6). The power of s may then be replaced by quantity S=(s2)²+(s3)². In some examples, such a replacement may result in the same number of data samples input into the SIR estimator 40 independent of the modulation order. Using the specific example values above, the combined power of s2, s3 symbols may then equal 2/10 which may be compensated when calculating a final SIR value, such as by using equation (4).

In some example embodiments an SIR estimation may include a SIR estimation for 64 QAM data. In an example embodiment, the demodulator 36 may implement a slicer algorithm to obtain the soft bits. An example is:

$$\{ \begin{matrix}s 0 = real ( s ) \\ s 1 = imag ( s ) \\ s 2 = Th - abs ( real ( s ) ) \\ s 3 = Th - abs ( imag ( s ) ) \\ s 4 = Th / 2 - abs ( Th - abs ( real ( s ) ) ) \\ s 5 = Th / 2 - abs ( Th - abs ( imag ( s ) ) )\end{matrix} \qquad ( 7 )$$

where Th is a threshold which for the normalised constellation (data symbol power equals unity) in some example embodiments is represented by Th=4/\sqrt{42}. As is shown above, soft bits s4, s5 may have a constant amplitude. As was described with respect to 16 QAM modulation, the one or more data symbols output from the detector 34 may be replaced by the demodulated symbols s4, s5. Alternatively or additionally, replacement using demodulated data in the form of soft bits having a constant amplitude may be extended to higher order modulation, e.g. 256 QAM data and/or the like.

In some example embodiments, the processing circuitry 22, the processor 24 and/or the communication interface 30 may be configured to detect from the one or more data symbols output from the detector 34 an instance in which a signal s contains mostly noise. In such example cases, the SIR estimator 40 may then use data symbols output from the detector 34 instead of the soft bits from the demodulator 36 for SIR estimation. For the detection of noise, a ratio between the quantities M₂ and \sqrt{M₄}, where M₂ and M₄ denote the already estimated moments, may be used. By way of example and with respect to 16 QAM data, M₂ and M₄ from the data symbols using Equation (5) may be calculated. One such ratio may be defined as the ratio between M₂ and T\sqrt{M₄}. The ratio of M₂ and T\sqrt{M₄} identifies an instance in which a signal s contains mostly noise. For example, in an instance in which, M₂>T\sqrt{M₄}, the signal s contains mostly noise and the data may then be demodulated by the demodulator 36 and the processing circuitry 22, the processor 24 or the like may recalculate M₂ and M₄ using soft bits s2, s3. By way of a further example, in an instance in which M₂<T\sqrt{M₄}, then the values M₂ and M₄ are not recalculated. As a specific example, in some example embodiments T may take the value of 0.82, however in alternate embodiments other values of T may be used for a plurality of signals. An SIR may be calculated using (Equation (4)) based on updated moments M₂ and M₄.

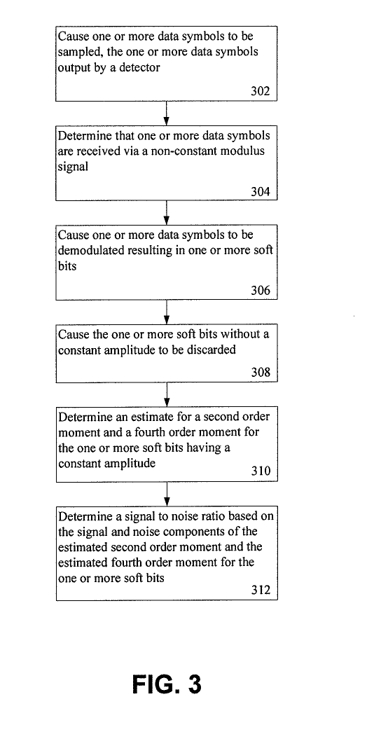

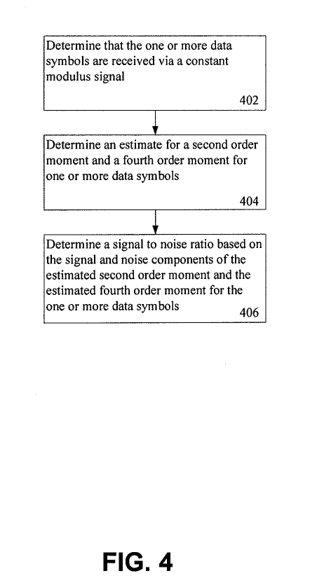

FIGS. 3 and 4 illustrate example operations performed by a method, apparatus and computer program product, such as apparatus 20 of FIG. 2 in accordance with one embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 26 of an apparatus employing an embodiment of the present invention and executed by a processor 24 in the apparatus. As will be appreciated, any such computer program instructions may be loaded onto a computer or other programmable apparatus (e.g. hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 3 and 4, when executed, convert a computer or processing circuitry into a particular machine configured to perform an example embodiment of the present invention. Accordingly, the operations of FIGS. 3 and 4 define an algorithm for configuring a computer or processing circuitry 22, e.g. processor, to perform an example embodiment. In some cases, a general purpose computer may be provided with an instance of the processor which performs the algorithm of FIGS. 3 and 4 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein.

FIG. 3 shows a flow chart illustrating operations performed by an example receiver in accordance with some example embodiments of the present invention. In some example embodiments, the apparatus 20 embodied, for example, by a receiver such as communication device 10, such as the processing circuitry 22, the processor 24, the communication interface 30 or the like, is configured to estimate an SIR for non-constant modulus data.

At operation 302, the apparatus 20 embodied, for example, by a receiver such as communication device 10, and which may include means, such as the processing circuitry 22, the processor 24, the communication interface 30, a detector 34, a demodulator 36, a decoder 38, an SIR estimator 40 or the like, causes one or more data symbols to be sampled, the one or more data symbols being output by a detector. At operation 304, the apparatus 20 determines that one or more data symbols are received via a non-constant modulus signal. At operation 306, the apparatus 20 causes one or more data symbols to be demodulated resulting in one or more soft bits.

At operation 308, the apparatus 20 causes the one or more soft bits with non-constant amplitude to be discarded. At operation 310, the apparatus 20 determines an estimate for a second order moment and a fourth order moment for the one or more soft bits having a constant amplitude. At operation 312, the apparatus 20 determines a signal to noise ratio based on the signal and noise components of the estimated second order moment and the estimated fourth order moment for the one or more soft bits.

FIG. 4 is a flow chart illustrating operations performed by an example receiver in accordance with some example embodiments of the present invention. In some example embodiments, the apparatus 20 embodied, for example, by a receiver such as communication device 10, such as the processing circuitry 22, the processor 24, the communication interface 30 or the like, may be further configured to estimate an SIR for constant modulus data.

At operation 402, the apparatus 20 embodied, for example, by a receiver such as communication device 10, and which may include means, such as the processing circuitry 22, the processor 24, the communication interface 30, a detector 34, an SIR estimator 40 or the like, determines that the one or more data symbols are received via a constant modulus signal. At operation 404, the apparatus 20 determines an estimate for a second order moment and a fourth order moment for one or more data symbols. At operation 406, the apparatus 20 determines a signal to noise ratio based on the signal and noise components of the estimated second order moment and the estimated fourth order moment for the one or more data symbols.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Moreover, although the foregoing description and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method of signal to noise/interference ratio estimation, the method comprising:
causing one or more data symbols to be demodulated resulting in one or more soft bits;
determining, using a processor, an estimate for a second order moment and a fourth order moment using at least some of the one or more soft bits; and
estimating a signal to noise/interference ratio based on the estimated second order moment and the estimated fourth order moment for the one or more soft bits.

2. The method according to claim 1, wherein the one or more data symbols are sampled from one or more data symbols output by a detector.

3. The method according to claim 1, comprising:
determining that one or more of the data symbols are received via a non-constant modulus signal.

4. The method according to claim 3, wherein the one or more data symbols that are received via the non-constant modulus signal are modulated via at least one of 16 QAM modulation or 64 QAM modulation.

5. The method according to claim 3, wherein the one or more data symbols that are received via the non-constant modulus signal are modulated via higher order modulation.

6. The method according to claim 1, comprising:
causing soft bits without a constant amplitude to be discarded.

7. An apparatus comprising:
at least one processor; and
at least one memory including computer program code, the at least one memory and the computer program code configured to, with the at least one processor, cause the apparatus to at least:
cause one or more data symbols to be demodulated resulting in one or more soft bits;
determine an estimate for a second order moment and a fourth order moment using at least some of the one or more soft bits; and
estimate a signal to noise/interference ratio based on the estimated second order moment and the estimated fourth order moment for the one or more soft bits.

8. The apparatus according to claim 7, wherein the at least one memory including the computer program code is further configured to, with the at least one processor, cause the apparatus to:
sample the one or more data symbols from one or more data symbols output by a detector.

9. The apparatus according to claim 7, wherein the processing system is arranged to cause the apparatus to:
determine that one or more of the data symbols are received via a non-constant modulus signal.

10. The apparatus according to claim 9, wherein the one or more data symbols that are received via the non-constant modulus signal are modulated via at least one of 16 QAM modulation or 64 QAM modulation.

11. The apparatus according to claim 9, wherein the one or more data symbols that are received via the non-constant modulus signal are modulated via higher order modulation.

12. The apparatus according to claim 7, wherein the processing system is arranged to cause the apparatus to:
cause soft bits without a constant amplitude to be discarded.

13. The apparatus according to claim 7, wherein the apparatus comprises at least one of an access point, user equipment or a communications device.

14. The apparatus according to claim 7, wherein the apparatus is configured for use in at least one of a wideband code division multiple access, time division synchronous code division multiple access, a Long Term Evolution or Long Term Evolution Advanced system.

15. An apparatus comprising:
at least one processor; and
at least one memory including computer program code, the at least one memory and the computer program code configured to, with the at least one processor, cause the apparatus to at least:
determine whether one or more received data symbols are received via a constant modulus signal or a non-constant modulus signal; and
(a) in an instance in which the one or more of the received data symbols are received via a constant modulus signal: determine an estimate for a second order moment and a fourth order moment using the one or more of the data symbols that are received via a constant modulus signal, and determine a signal to noise/interference ratio based on the estimated second order moment and the estimated fourth order moment for the one or more data symbols that are received via a constant modulus signal; and
(b) in an instance in which the one or more of the received data symbols are received via a non-constant modulus signal: determine an estimate for a second order moment and a fourth order moment using at least some of one or more soft bits that are output by a demodulator which demodulates the one or more received data symbols, and estimate a signal to noise/interference ratio based on the estimated second order moment and the estimated fourth order moment for the one or more soft bits.

16. The apparatus according to claim 15, wherein the at least one memory including the computer program code is further configured to, with the at least one processor, cause the apparatus to:
determine that one or more of the received data symbols have a level of noise that surpasses a threshold; and
(c) in an instance in which the one or more of the received data symbols have a level of noise that surpasses the threshold, determine an estimate for a second order moment and a fourth order moment using at least some of the received data symbols that have a level of noise that surpasses the threshold, and determine a signal to noise/interference ratio based on the estimated second order moment and the estimated fourth order moment for the at least some of the received data symbols that have a level of noise that surpasses the threshold.

17. The apparatus according to claim 15, wherein the apparatus comprises at least one of an access point, user equipment or a communications device.

18. The apparatus according to claim 15, wherein the apparatus is configured for use in at least one of a wideband code division multiple access, time division synchronous code division multiple access, a Long Term Evolution or Long Term Evolution Advanced system.
